(19) United States
(12) Patent Application Publication
(10) Pub. No.: US 2021/0028500 A1
(43) Pub. Date: Jan. 28, 2021

(54) ELECTROLYTE SOLUTION, BATTERY AND BATTERY PACK

(71) Applicant: AAB Technology (HK) Limited, Kowloon (HK)

(72) Inventor: Zhonglai Pan, Hong Kong (CN)

(21) Appl. No.: 16/938,827

(22) Filed: Jul. 24, 2020

Related U.S. Application Data
(60) Provisional application No. 62/879,168, filed on Jul. 26, 2019.

(30) Foreign Application Priority Data
Apr. 27, 2020 (CN) 202010344929.1

(51) Int. Cl. H01M 10/36; H01M 4/38; H01M 4/24; H01M 2/10

(52) U.S. Cl. CPC H01M 10/36; H01M 4/382; H01M 2300/0014; H01M 2/1077; H01M 4/244

(57) ABSTRACT

An electrolyte solution, a battery and a battery pack are provided. The electrolyte solution includes an aqueous electrolyte and an additive system. The additive system includes a neutral alkali metal salt and oxygen-enriched compound. The battery includes the electrolyte solution, a cathode and an anode. The battery pack includes a plurality of the batteries.

### CROSS REFERENCE TO RELATED APPLICATION

This application claims priority to U.S. Provisional Patent Application No. 62/879,168 filed on Jul. 26, 2019, and China Patent Application No. 202010344929.1 filed on Apr. 27, 2020; each of which is hereby incorporated by reference in its entirety.

### FIELD OF THE INVENTION

This invention relates to an electrolyte solution for an aqueous battery, and a battery and battery pack utilizing the electrolyte solution, belonging to the technical field of secondary batteries.

### BACKGROUND OF THE INVENTION

With the escalating demands towards smaller portable devices, suitable sustainable power sources are being sought that are efficient, compact, lightweight and safe.

Rechargeable batteries are commonly used as power sources, adjusting to meet the demands of more powerful low cost, and large grid-scale energy storage systems. Recently, various aqueous electrolyte based rechargeable batteries have been sought after that possess safe, high power, large grid-scale energy storage systems. In particular, aqueous electrolyte batteries containing anodes with zinc metal (zinc-ion batteries) have shown to be promising due to their abundance, higher stability, low cost, and nontoxic properties, making these rechargeable zinc-ion batteries particularly attractive. However, there are disadvantages associated with these types of alkaline batteries.

Typically, in aqueous alkaline batteries, these batteries can exhibit low cyclability due to the use of alkaline electrolytes, which can be very corrosive and lead to the degradation of intercalation of electrodes in both the cathode and anode. Furthermore, the presence of alkaline electrolytes can be dangerous to both the environment and the human body if a leakage occurs.

Traditional non-aqueous lithium ion batteries have been used as a rechargeable battery because of their high energy density. However, these non-aqueous lithium ion batteries display unsafe characteristics, are toxic and can pose environmental risks. While aqueous lithium ion batteries offer great advantages as a rechargeable battery due to their high energy density and low self-discharge rate; alternatives to lower the high cost, and address the poor safety issues associated with flammable organic electrolytes that have been addressed.

In addition, another disadvantage associated with these types of batteries includes limited battery cell performance during the repeated charging and discharging process, by the dissolution of zinc and the un-uniform buildup of zinc metal precipitate depositing on the surfaces of the anode commonly referred to as zinc dendrite formation. The effects of these limitations can be disastrous since the presence of dendrite formation can result in corrosion, self-discharge and potentially a short circuit, which can pose a hazardous safety risk and a shortened battery cycle life.

In order to overcome the aforementioned limitations, additives have been incorporated into rechargeable batteries to increase charge capacity and to suppress dendrite formation. Additives offer tremendous advantages in rechargeable batteries due to their ability to regulate ion transport, thus having a strong impact on battery cell production, rate performance, and battery life. Typical additives that have been used include the addition of polyethylene glycol, polyethylene glycol octyl phenyl ether and polyvinyl alcohol to electrolyte solutions. These oxygen-enriched compounds can inhibit corrosion and the generation of dendrites. Additionally, magnesium sulfate has been added into electrolyte solutions to inhibit the generation of dendrites, corrosion and hydrogen evolution in an aqueous solution during charging and discharging of anode metal ions (such as zinc ions).

For the foregoing reasons, there exists a need for an electrolyte solution for an aqueous battery, and a battery and battery pack utilizing the electrolyte solution, which exhibit excellent electrochemical performance, effectively inhibits dendrite formation, has high capacity and enhances cycling stability. Further, it would be advantageous to have additives for the electrolyte solution to be fast and stable in response to charge, and be able to maintain its performance for prolonged periods of time. Still further, it would be advantageous to have a battery and battery pack containing this electrolyte solution, which is efficient, safe and effective and low cost.

### SUMMARY

The present invention is directed to an electrolyte solution for an aqueous battery, and a battery and battery pack utilizing the electrolyte solution, that can be applied to aqueous zinc batteries to dissolve zinc precipitate and inhibit the generation of dendrites.

In accordance with the present disclosure, the electrolyte solution comprises an aqueous electrolyte and an additive system, wherein the additive system comprises a neutral alkali metal salt (NAMS) and an oxygen-enriched compound. The aqueous electrolyte contains anode metal ions that can be reduced and deposited to form metal at an anode electrode during charge-discharge process, whereby the metal can be reversibly oxidized and dissolved.

According to a preferred embodiment of the disclosure, the neutral alkali metal salt comprises an alkali metal sulfate.

In a preferred embodiment of the disclosure, the neutral alkali metal salt comprises at least one salt selected from the group consisting of sodium, potassium, ruthenium and cesium (Na, K, Ru and Cs) salts.

In a most preferred embodiment of the disclosure, the neutral alkali metal salt is at least one of sodium sulfate, potassium sulfate, rubidium sulfate and cesium sulfate.

In an embodiment of the disclosure, the neutral alkali metal salt is present in a molar concentration from about 0.1M to about 0.8M.

In an embodiment of the disclosure, the oxygen-enriched compound comprises at least one of polyethylene glycol, polysorbate, nonylphenol polyethylene glycol ether, polyoxyethylene octyl phenyl ether, polypropylene glycol, polyglycerol and polyethyleneimine.

In a preferred embodiment of the disclosure, the oxygen-enriched compound is polyethylene glycol (PEG). In a most preferred embodiment of the disclosure, the oxygen-enriched compound is polyethylene glycol with a weight-average molecular weight from about 200 Da to about 2000 Da.

In an embodiment of the disclosure, the oxygen-enriched compound is present in a concentration from about 100 ppm to about 200000 ppm by weight.

In an embodiment of the disclosure, the electrolyte solution comprises an electrolyte having a pH from about pH 4 to about pH 6.

In an embodiment of the disclosure, the anode metal ion comprises zinc ions.

In an embodiment of the disclosure, the aqueous electrolyte comprises zinc ions and lithium ions.

In a preferred embodiment of the disclosure, the zinc ions are present in a concentration from about 0.1M to about 3 M; and the lithium ions are present in a concentration from about 0.1M to about 3 M.

In an embodiment of the disclosure, the electrolyte solution contains a solvent that is at least one of water and alcohol.

In a preferred embodiment of the disclosure, the solvent is water.

The disclosure also provides a battery. The battery in the disclosure comprises a cathode, an anode and electrolyte solution. The electrolyte solution comprises an aqueous electrolyte and an additive system, wherein the additive system comprises a neutral alkali metal salt (NAMS) and an oxygen-enriched compound. The aqueous electrolyte contains anode metal ions that can be reduced and deposited to form metal at an anode electrode during charge-discharge process, whereby the metal can be reversibly oxidized and dissolved.

The battery additive system comprises one or more neutral alkaline salts selected from the group consisting of sodium, potassium, ruthenium and cesium (Na, K, Ru and Cs) salts.

In an embodiment of the disclosure, the cathode comprises a lithium-base electrode material.

In an embodiment of the disclosure, the anode comprises a zinc-based electrode material.

The disclosure also provides a battery pack. The battery pack in the disclosure comprises a plurality of batteries. The battery in the disclosure comprises a cathode, an anode and electrolyte solution. The electrolyte solution comprises an aqueous electrolyte and an additive system, wherein the additive system comprises a neutral alkali metal salt (NAMS) and an oxygen-enriched compound. The aqueous electrolyte contains anode metal ions that can be reduced and deposited to form metal at an anode electrode during charge-discharge process, whereby the metal can be reversibly oxidized and dissolved.

In a preferred embodiment of the present disclosure, a neutral alkali metal salt and an oxygen-enriched compound such as polyethylene glycol (PEG) are added into the electrolyte solution for in-situ dissolution of zinc hydroxide precipitate; rearranging the zinc hydroxide precipitate; unblocking ion channels; inhibiting the generation of metal dendrites; and increasing the battery capacity and cycle life.

The present disclosure is directed to systems and compositions to batteries that have lithium-based cathodes and zinc-based anodes in an aqueous electrolyte, and a battery additive system, which delays battery capacity decay. However, the systems and compositions described may be applicable to other cells and batteries that may have an aqueous electrolyte, which exhibit battery capacity decay and an anode on which dendrites can grow. The battery additive system described herein may be applied to resist, impede, and suppress battery capacity decay and to inhibit and/or prevent dendrite formation.

### BRIEF DESCRIPTION OF THE DRAWINGS

These and other features, aspects, and advantages of the present disclosure will become better understood with reference to the following description, appended claims and accompanying drawings wherein:

FIG. 1 illustrates the change in concentration of soluble salts in a lithium-based cathode zinc-based anode cell without the additive system of the present disclosure before cycle and after cycle of charging and discharging for 100 times.

FIG. 2 illustrates the addition of neutral alkali metal salts to channels blocked by Zn₂(OH)₂SO₄ resulting in unblocked channels according to an embodiment of the present disclosure.

FIG. 3 illustrates the constant-current ratio retention rate of batteries with and without the additive system (NAM, polyethylene glycol and both NAM and polyethylene glycol) according to an embodiment of the disclosure.

FIG. 4 shows the 0.2 C cycle performance of four groups of batteries with and without the additive system (NAM, polyethylene glycol and both NAM and polyethylene glycol) as seen in Example 1 according to an embodiment of the present disclosure.

FIG. 5 shows the 0.2 and 0.5 C cycle performance of batteries with and without the additive system (NAM, polyethylene glycol and both NAM and polyethylene glycol) at different rates as seen in Example 2 according to an embodiment of the present disclosure.

FIG. 6 shows the cycle performance of batteries with additive system (both NAM and polyethylene glycol; using sodium salt and potassium salt as the neutral alkali metal salt) as seen in Example 3 according to an embodiment of the present disclosure.

FIG. 7 shows the cycle performance of batteries with and without the additive system (NAM, polyethylene glycol and both NAM and polyethylene glycol; using different ion concentrations) as seen in Example 4 according to an embodiment of the present disclosure.

FIG. 8 shows the cycle performance of batteries with and without the additive system (NAM, polyethylene glycol and both NAM and polyethylene glycol; using different ion concentrations) as seen in Example 5 according to an embodiment of the present disclosure.

FIG. 9 shows the cycle performance of batteries with and without the additive system (NAM, polyethylene glycol and both NAM and polyethylene glycol; using different ion concentrations and varying the molecular weight and ppm of polyethylene glycol) as seen in Example 6.

FIG. 10 shows the cycle performance of batteries with and without the additive system (NAM, polyethylene glycol and both NAM and polyethylene glycol; using different ion concentrations and varying the molecular weight and ppm of polyethylene glycol) as seen in Example 7.

FIG. 11 shows the cycle performance of batteries with and without the additive system (NAM, polyethylene glycol and both NAM and polyethylene glycol; using different ion concentrations and varying the molecular weight and ppm of polyethylene glycol) as seen in Example 8.

FIG. 12 shows the cycle performance of batteries with and without the additive system (NAM, polyethylene glycol and both NAM and polyethylene glycol; using different ion concentrations and varying the molecular weight and ppm of polyethylene glycol) as seen in Example 9.

These and other features, aspects, and advantages of the present invention will become better understood with reference to the following description.

### DETAILED DESCRIPTION OF EMBODIMENTS

In the descriptions presented below, reference may be made to an aqueous zin ion battery. Various embodiments of an electrolyte solution with an additive system for aqueous zinc-ion batteries are disclosed. However, the electrolyte solution described herein may be applicable to other non zinc-ion based battery cells and battery packs.

The electrolyte solution containing an additive system for a battery described herein may be applied to resist, impede, and suppress battery capacity decay and to inhibit and/or prevent dendrite formation.

According to an embodiment of the present disclosure, an aqueous zinc-ion battery comprising a cell is provided. The battery cell can include a pair of electrodes; and an aqueous electrolyte solution comprising an additive system which delays battery capacity delay. Preferably, the pair of electrodes comprises a positive electrode (a cathode) and a negative electrode (an anode). The zinc-ion battery can further include a separator. In an embodiment of the present disclosure, the cathode preferably is a lithium-ion based cathode and the anode is a zinc-ion based anode. In this type of battery, during charging, the deintercalation of lithium-ion typically occurs at the cathode, and the reduction and deposition of zinc ion occurs at the anode. Typically, during discharging, intercalation of lithium ion occurs at the cathode, and oxidation and dissolution of zinc ion occurs at the zinc anode.

Battery cell performance is often limited during the repeated charging and discharging process in these zinc based and lithium based batteries, which can lead to poor cycle performance. These limitations can be attributed to the formation of insoluble zinc hydroxide precipitate depositing in the porous electrode, thus lowering the capacity of the battery.

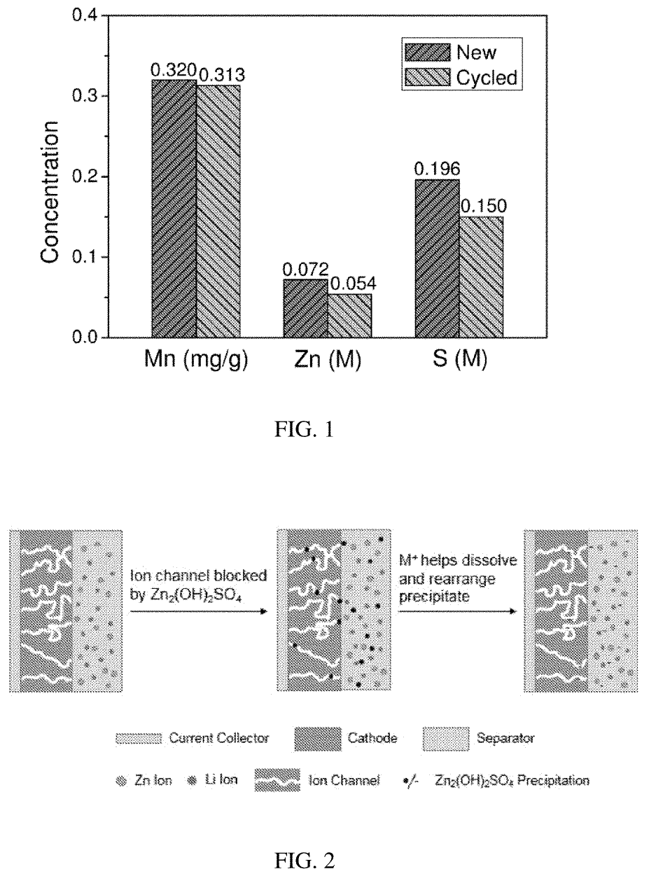

FIG. 1, illustrates the concentration variation of soluble salts in an electrolyte solution of a conventional zinc and lithium based battery before cycle use and after cycle charging and discharging for 100 times. The concentration is obtained through cycling tested by an X-ray fluorescence analyzer (EDX-LE XRF). As shown in FIG. 1, Zn²⁺ and SO₄²⁻ in the electrolyte solution significantly decreases after 100 times of cycle, indicating that insoluble Zn₂(OH)₂SO₄ precipitate has formed in the battery after many times of cycle. Such precipitate can enter the porous electrode and block the ion channel therein, thus affecting ion transmission, increasing internal resistance of the electrode and reducing the capacity.

During charging and discharging the reduction and precipitation of anode metal ions at the anode (i.e. negative pole) are known to generate metal dendrites and particularly, in a zinc and lithium based battery, can cause the generation of zinc dendrites on the surfaces of the anode. Due to the repeated charging and discharging cycle, the zinc dendrites may grow outwards from the anode, further piercing the separator and even approaching the cathode. When a zinc dendrite reaches the cathode, the zinc metal containing dendrite can create a short circuit between the electrodes. Such a short circuit can result in battery failure, and can further impose a safety risk due to overheating of the battery which can further lead to potential safety hazards, such as a “fire”. Therefore, dendrite growth should be inhibited in these zinc and lithium based batteries.

Furthermore, the existing conventional aqueous zinc battery typically has a small volume and a small capacity. For example, if the volume is increased, the electrode and the area of current collector can be increased accordingly, which can lead to the following deficiencies: 1) the voltage and current distribution on the battery plate of large area can be relatively uneven, resulting in local overpotential on the positive pole surface, and further side reaction of zinc salt precipitation; 2) the negative pole surface can also produce local overpotential, thus increasing dendrite growth and zinc precipitation, and 3) large surface current density is more likely to cause side reactions. Therefore, the problems of dendrite and channel blockage need to be solved in order to manufacture aqueous zinc batteries of large volume.

The present disclosure meets the aforementioned needs. In a preferred exemplary embodiment of this disclosure, it has been found that the addition of neutral alkali metal salts and oxygen-enriched compounds to the electrolyte solution not only helps dissolve and rearrange Zn₂(OH)₂SO₄ precipitate, but can also unblock the internal channel of the electrode to maintain better capacity, inhibits and/or prevents the formation of dendrites, and maintains good cycle performance of the battery.

In an embodiment of the disclosure, the electrolyte solution comprises an aqueous electrolyte and an additive system. The additive system comprises a neutral alkali metal salt and an oxygen-enriched compound, and the aqueous electrolyte contains an anode metal ion that can reduce the precipitate at the anode to metal capable of reversibly oxidizing the dissolved anode metal ions.

According to an embodiment of the present disclosure, the aqueous electrolyte is any inorganic salt known to those skilled in the art, and has the function of ion transmission. Preferably, the electrolyte solution of the present disclosure, further comprises the addition of an aqueous electrolyte to the additive system (neutral alkali metal salt and the oxygen-enriched compound) to promote ion transmission, dissolve zinc precipitates, inhibit zinc dendrites and improve cycle performance of the battery.

In an embodiment of the disclosure, the neutral alkali metal salt is an alkali metal sulfate. Addition of the alkali metal sulfate can cause alkali metal ions to be released in the electrolyte solution without introducing other anions to affect electrochemical performance. In the presence of hydroxy anions, the alkali metal sulfate can dissolve zinc hydroxide precipitate in situ, further rearrange the zinc hydroxide precipitate and unblock the channels (FIG. 2). The principle is as follows:

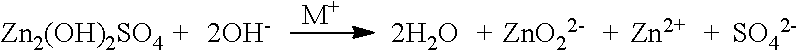

Herein, “M+” represents alkali metal ions.

In an embodiment of the disclosure, the neutral alkali metal salt is at least one of sodium sulfate, potassium sulfate, rubidium sulfate and cesium sulfate. As known to those skilled in the art, metallicity and alkalinity of hydroxide of neutral alkali metal salt tends to increase gradually from Na, K, Ru to CS, indicating that the zinc hydroxide precipitate is easier to dissolve in situ. In practice, other parameters such as the solubility of neutral alkali metal salt, the radius and the cost of hydrated ion of an alkali atom, should be considered. Preferably, the molar concentration of the neutral alkali metal salt in the electrolyte solution is from about 0.1M to about 0.8M. The symbol “M” used in the disclosure is the short for mol/L, the unit of molar concentration.

In some embodiments of the present disclosure, the molar concentration of neutral alkali metal salt in the electrolyte solution can be 0.1M, 0.15M, 0.2M, 0.25M, 0.3M, 0.35M, 0.4M, 0.45M, 0.5M, 0.55M, 0.6M, 0.65M, 0.7M, 0.75M, 0.8M, etc.

Oxygen-enriched compounds are usually molecules rich in oxygen atoms and are typically added into battery electrolyte solutions. Addition of these oxygen-enriched compounds are known to lead zinc ions to precipitate uniformly, prevent zinc from accumulating and prevent the growth of dendrites between the electrodes of the battery; thus preventing the battery from short circuiting and improving the cycle performance. Any oxygen-enriched compound known to those skilled in the art can be used. In an embodiment of the present disclosure, the oxygen-enriched compound can be polyethylene glycol and its derivatives, such as polysorbate, nonylphenol polyethylene glycol ether, polyoxyethylene octyl phenyl ether, or other oxygen-enriched compounds such as polypropylene glycol, polyglycerol, and heteroatomic nitrogen compounds such as polyethyleneimine.

In a preferred embodiment, the oxygen-enriched compound is polyethylene glycol known herein as “PEG”. In a most preferred embodiment, the oxygen-enriched compound is polyethylene glycol with a weight-average molecular weight (M_{w}) of about 200 Da to about 2000 Da. Unless otherwise specified, the molecular weight in the disclosure is the weight average molecular weight.

In accordance to an embodiment of the present disclosure, the concentration of oxygen-enriched compound in the electrolyte solution is from about 100 ppm to about 200000 ppm by weight. In some embodiments of the disclosure, the concentration of oxygen-enriched compounds in the electrolyte solution can be 100 ppm, 500 ppm, 1000 ppm, 1500 ppm, 2000 ppm, 5000 ppm, 10000 ppm, 15000 ppm, 20000 ppm, 50000 ppm, 100000 ppm, 130000 ppm, 150000 ppm, 180000 ppm, 200000 ppm, etc. by weight.

In yet another preferred embodiment of the present disclosure, the neutral alkali metal salt and the oxygen-enriched compound can be in any combination thereof without affecting the effect of the disclosure. This includes but is not limited to the following combinations: sodium sulfate and polyethylene glycol, sodium sulfate and polysorbate, sodium sulfate and nonylphenol polyethylene glycol ether, sodium sulfate and polyoxyethylene octyl phenyl ether, sodium sulfate and polypropylene glycol, sodium sulfate and polyglycerol, sodium sulfate and polyethyleneimine, potassium sulfate and polyethylene glycol, potassium sulfate and polysorbate, potassium sulfate and nonylphenol polyethylene glycol ether, potassium sulfate and polyoxyethylene octyl phenyl ether, potassium sulfate and polypropylene glycol, potassium sulfate and polyglycerol, potassium sulfate and polyethyleneimine, rubidium sulfate and polyethylene glycol, rubidium sulfate and polysorbate, rubidium sulfate and nonylphenol polyethylene glycol ether, rubidium sulfate and polyoxyethylene octyl phenyl ether, rubidium sulfate and polypropylene glycol, rubidium sulfate and polyglycerol, rubidium sulfate and polyethyleneimine, cesium sulfate and polyethylene glycol, cesium sulfate and polysorbate, cesium sulfate and nonylphenol polyethylene glycol ether, cesium sulfate and polyoxyethylene octyl phenyl ether, cesium sulfate and polypropylene glycol, cesium sulfate and polyglycerol, and cesium sulfate and polyethyleneimine.

In yet another preferred embodiment of the disclosure, in order to optimize the performance of the battery, the pH value of the electrolyte solution typically is from about pH 4 to about pH 6 providing a weak acid battery system. According to the present disclosure, a weak acid battery system with pH value of between pH 4 to pH 6 can prevent the precipitate of zinc hydroxide, the additive system can also promote in-situ dissolution of zinc hydroxide precipitate, further rearrange zinc hydroxide precipitate and unblock the channels. The range of pH can further be adjusted by any buffer agent known to those skilled in the art.

In some embodiments of the disclosure, the pH value of the electrolyte solution can be pH4, pH4.3, pH4.5, pH4.7, pH5, pH5.3, pH5.5, pH5.8, pH6, etc. In a preferred embodiment, the pH of the electrolyte solution is 4.7.

In an embodiment of the present disclosure, the anode metal ions in the electrolyte solution can be reduced and deposited to metal during the charging process, and the metal can be reversibly oxidized into metal ions during the discharging process. More specifically, during battery charging, the anode metal ions in the electrolyte solution are reduced to metal and deposit on the anode; and, during battery discharging, the metal is oxidized to metal ions and dissolved on the anode and then enters the electrolyte solution. In a preferred embodiment of the present disclosure, the anode metal ion is zinc ion. In a preferred embodiment, the molar concentration of zinc ion is from about 0.1M to about 3M. In some embodiments of the disclosure, the molar concentration of zinc ion can be 0.1M, 0.3M, 0.5M, 0.7M, 1M, 1.2M, 1.5M, 1.8M, 2M, 2.1M, 2.4M, 2.5M, 2.8M, 3M, etc.

In yet another embodiment of the present disclosure, anode metal ions can exist in the electrolyte solution in the form of and not limited to chlorate, sulfate, nitrate, acetate, formate, phosphate and any chemical group known to those skilled in the art to form with metal ion; preferably, the anode metal ions exist in the electrolyte solution in the form of sulfate.

The electrolyte solution in the present disclosure can also include cathode ions participating in the cathode reaction. The cathode ions can be the metal ions intercalated and deintercalated at the cathode of the battery or the ions participating in the redox reaction at the cathode during charging and discharging process.

In an embodiment of the disclosure, the cathode ions are metal ions which are intercalated and deintercalated at the cathode of the battery. During battery charging, the cathode ions in the cathode can escape into the electrolyte solution. During battery discharging, the ions escaping from the electrolyte solution can be intercalated into the cathode material. In an embodiment, the cathode ion is lithium ion. In a preferred embodiment, the molar concentration of lithium ion is from about 0.1M to about 3M. In some embodiments of the disclosure, the molar concentration of lithium ion can be 0.1M, 0.3M, 0.5M, 0.7M, 1M, 1.2M, 1.5M, 1.8M, 2M, 2.1M, 2.4M, 2.5M, 2.8M, 3M, etc.

Cathode ions can exist in the electrolyte solution in the form of and not limited to chlorate, sulfate, nitrate, acetate, formate, phosphate and so on. Preferably, the cathode ions exist in the electrolyte solution in the form of sulfate.

The electrolyte solution in the present disclosure can further comprise a solvent. Typically, the solvent is used to dissolve the aqueous electrolyte and additive system, ionize the electrolyte in the solvent, and generate cations and anions that are free to move in the electrolyte solution.

In a preferred embodiment, the solvent in the disclosure preferably comprises at least one of water and alcohol; wherein, the alcohol includes but is not limited to methanol or ethanol. More preferably, the solvent is water in order to save cost and reduce the risk of environmental pollution.

The disclosure also provides a battery that comprises a cathode, an anode and electrolyte solution. The electrolyte solution of a preferred embodiment of the disclosure is as previously described above herein.

In an embodiment of the disclosure, the cathode can include a negative pole current collector and a cathode active substance.

According to the present disclosure, the negative pole current collector can be any negative pole current collector known to those skilled in the art, and can be selected without restrictions accordingly. As the carrier of electron transmission and collection, the negative pole current collector typically does not participate in the electrochemical reaction. That is, within the range of operating voltage of the battery, the negative pole current collector can stably exist in the electrolyte solution without any side reaction, to ensure the stable cycle performance of the battery. The size of the negative pole current collector can be determined according to the use of the battery. For example, a large-area negative pole current collector can be used for a large battery that requires a high energy density. There is no special restriction on the thickness of the negative pole current collector, usually about from about 1-100 μm. There is also no special restriction on the shape of the negative pole current collector. The negative pole current collector can be a rectangle or a circle. There is no special restriction on the materials of the negative pole current collector. For example, metal, alloy and carbon-based materials can be used.

In an embodiment of the present disclosure, a cathode active substance can exist on the negative pole current collector. The cathode active substance can form on one or two side(s) of the negative pole current collector. The cathode active substance in the disclosure, can be any known to those skilled in the art, as long as it can reversibly intercalate and de-intercalate metal ions and can be selected accordingly.

In an embodiment of the disclosure, the cathode preferably is made of a lithium-based electrode material, and the metal ions that can be reversibly intercalated and deintercalated are lithium ions. In a preferred embodiment, the cathode active substance can be selected from the group consisting of lithium manganate, lithium nickel cobalt manganese oxide and lithium iron phosphate.

According to an embodiment of the disclosure, the cathode may further comprise an adhesive. Typically, adhesives are compounds that keep lithium-ion battery components together and are known to increase the life and capacity of these types of batteries. The adhesive can be any existing conventional adhesive and can be obtained from any commercial source known to those skilled in the art. The adhesive can be selected from and not limited to one or more of polyvinylidene fluoride, styrene butadiene rubber, carboxymethyl cellulose and any adhesive known to those skilled in the art.

According to an embodiment of the disclosure, the cathode can further comprise carbon black. In a detailed embodiment of the disclosure, carbon black can be used as a conductive additive in a composite cathode of a lithium-ion battery. It is known to those skilled in the art that carbon black is conducive to enhancing cathode recyclability. Carbon black can be obtained from any commercial source known to those skilled in the art. In a particular embodiment of the disclosure, the electrode composite may contain an amount of carbon black ranging from about 0.1 wt % to about 30 wt %.

In the embodiment of the disclosure, the anode can include a positive pole current collector and an anode active substance.

No special restriction is made on the positive pole current collector. The positive pole current collector preferably is used as the carrier of electron transmission and collection, and does not participate in the electrochemical reaction. The material of positive pole current collector can be Ni, Cu, Ag, Pb, Mn, Sn, Fe, Al or at least one of the above metals passivated, or silicon, or carbon-based materials, or stainless steel or passivated stainless steel.

An anode active substance can exist on the positive pole current collector. The anode active substance can form on one or two side(s) of the positive pole current collector. There are no special requirements for the anode active substance in the disclosure. Those skilled in the art can select it according to their needs.

In a preferred embodiment, the anode is made of a zinc-based electrode material, and the anode active substance is zinc.

In an embodiment, the anode active substance can be zinc powder, which is coated on the positive pole current collector with an adhesive. In another embodiment, the anode active substance can be a zinc plate, which is adhered to the current collector.

In a preferred embodiment, a zinc sheet is directly used as the anode, and serves as both the positive pole current collector and as the anode active substance. Preferably, the zinc sheet is the carrier for anode charging and discharging.

In a preferred embodiment, a lithium-based electrode material is used as the cathode and a zinc-based electrode material as the anode of the battery of the disclosure, thereby forming the zinc lithium based battery.

In the disclosure, the battery can further contain a separator, although it is not required. In order to provide better safety performance, the electrolyte solution is preferably provided with a separator between the cathode and the anode. The separator can avoid short circuit caused by connection between positive and negative poles due to other unexpected factors.

There are no special requirements for the separator of the disclosure, as long as it allows electrolyte solution and ions to pass through and is electronically insulated. In an embodiment of the present disclosure, any separator known to those skilled in the art that can be used for organic lithium-ion batteries can be applied. Generally, the separator allows the transport of at least some ions, including zinc ions, between the electrodes. Preferably, the separator can inhibit and/or prevent the formation of dendrites and the short circuit of batteries. The separator may be a porous material and can be obtained from any commercial source. It can be selected from at least one of glass fiber, non-woven fabric, asbestos film, non-woven polyethylene film, nylon, polyethylene, polypropylene, polyvinylidene fluoride, polyacrylonitrile, polyethylene/polypropylene double-layer separator and polypropylene/polypropylene/polypropylene three-layer separator.

As an embodiment of the disclosure, the electrolyte solution of the disclosure is used to assemble a large-volume battery, wherein the size of the battery current collector is 7.35 cm*4.45 cm, the surface density of the cathode material is 0.07 g/cm², and the 0.2 C current surface density is 1.1 mA/cm². According to the results of theoretical calculation and experimental test, the voltage difference between the upper and lower ends of the positive pole current collector is about 12 mV, and the 0.2 C charging current of the battery is 36 mA.

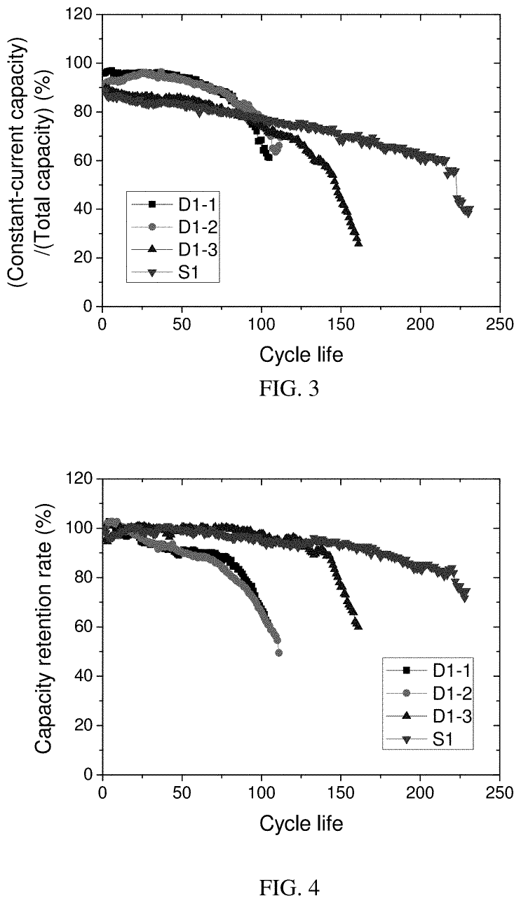

On battery plates of large area, the distribution of voltage and current can be relatively uneven, resulting in local overpotential on positive pole surface, further causing a side reaction of zinc salt precipitate, thus leading to higher difficulty in maintaining cycle retention rate. The NAMS helps dissolve the insoluble zinc salt precipitate produced by the side reaction on the positive pole surface and alleviates the increase of internal resistance of the battery (increasing the constant-current ratio retention rate), thus maintaining the electrode and increasing cycle life. FIG. 3 illustrates the constant-current ratio retention rate of the battery according to an embodiment of the disclosure. D1-1 is the electrolyte solution without any additives; D1-2 is that with neutral alkali metal salt; D1-3 is that with polyethylene glycol, and S1 is that with both neutral alkali metal salt and polyethylene glycol.

In addition, local overpotential produced on the negative pole surface can promote the growth of dendrites and side reactions such as zinc salt precipitates. According to an embodiment of the disclosure, the synergistic effect of NAMS and oxygen-enriched compounds (such as PEG) can alleviate side reactions and reduce zinc salt consumption, thus maintaining the electrolyte solution and the additive system effective and the negative pole stable.

Larger density of current surface is more likely to cause side reactions, so it is more difficult to maintain the cycle stable due to the use of large size battery. An additive system needs to be added into the electrolyte solution to improve the stability of cycle.

In yet another embodiment, the present disclosure also provides a battery pack, including some batteries described herein. The battery pack can comprise a battery module composed of a plurality of batteries. The batteries can be connected in series or in parallel. Preferably, the batteries are connected in series.

The following description will detail the exemplary preferred embodiments. The disclosure concept may be embodied in various forms without being limited to the exemplary embodiments set forth herein. Descriptions of well-known parts are omitted for clarity.

### Example 1

Preparation of electrolyte solution 1 (S1) comprises the following steps:

Weighing a certain amount of lithium sulfate, zinc sulfate, sodium sulfate and polyethylene glycol, adding them into deionized water and ensuring that the concentration of zinc ion, lithium ion, sodium ion is 2M, 2M and 0.8M respectively, the concentration of polyethylene glycol is 400 ppm and the molecular weight is 400, thus to obtain the electrolyte solution S1.

Preparation of control electrolyte solution 1 (D1-1) comprises the following steps:

Weighing a certain amount of lithium sulfate and zinc sulfate, adding them into deionized water to ensure that the concentration of zinc ion and lithium ion is 2.1M and 2.6M respectively, thus to obtain the electrolyte solution D1-1.

Preparation of control electrolyte solution 2 (D1-2) comprises the following steps:

Weighing a certain amount of lithium sulfate, zinc sulfate and sodium sulfate, adding them into deionized water to ensure that the concentration of zinc ion, lithium ion, sodium ion is 2M, 2M and 0.8M respectively, thus to obtain the electrolyte solution D1-2.

Preparation of control electrolyte solution 3 (D1-3) comprises the following steps:

Weighing a certain amount of lithium sulfate, zinc sulfate and polyethylene glycol, adding them into deionized water to ensure that the concentration of zinc ion, lithium ion and polyethylene glycol is 2.1M, 2.6M and 400 ppm respectively, thus to obtain the electrolyte solution D1-3.

Preparation of battery comprises the following steps:

Using the above electrolyte solutions S1, D1-1, D1-2 and D1-3 to assemble four batteries of large volume with the lithium-based battery material as the cathode and the zinc-based battery material as the anode. For the four packs of batteries, the same separator is used for the cathode and the anode, and the only difference is the electrolyte solution. The size of battery current collector is 7.35 cm*4.45 cm, and the surface density of cathode material is 0.07 g/cm².

Test of battery cycle performance:

Conduct 0.2 C charging and discharging test for the above four packs of batteries to test their cycle performance. FIG. 4 illustrates the 0.2 C cycle performance of the four groups of batteries. As shown in the figure, D1-1 is the electrolyte solution without any additives; D1-2 is that with neutral alkali metal salt; D1-3 is that with polyethylene glycol, and S1 is that with both neutral alkali metal salt and polyethylene glycol.

As shown in FIG. 4, addition of sodium sulfate into the electrolyte solution cannot improve the cycle performance, addition of PEG alone can improve the cycle performance to some extent, and addition of both sodium sulfate and PEG can highly improve the cycle performance and significantly increase the cycle life of the battery.

### Example 2

Preparation of electrolyte solution 2 (S2) comprises the following steps:

Weighing a certain amount of lithium sulfate, zinc sulfate, sodium sulfate and polyethylene glycol, adding them into deionized water to ensure that the concentration of zinc ion, lithium ion, sodium ion is 2M, 2.4M and 0.4M respectively, the concentration of polyethylene glycol is 400 ppm and the weight-average molecular weight is 400, thus to obtain the electrolyte solution S2.

Prepare the battery according to the method of Example 1 and test its cycle performance. Conduct 0.5 C charging and discharging test for the S2 electrolyte solution.

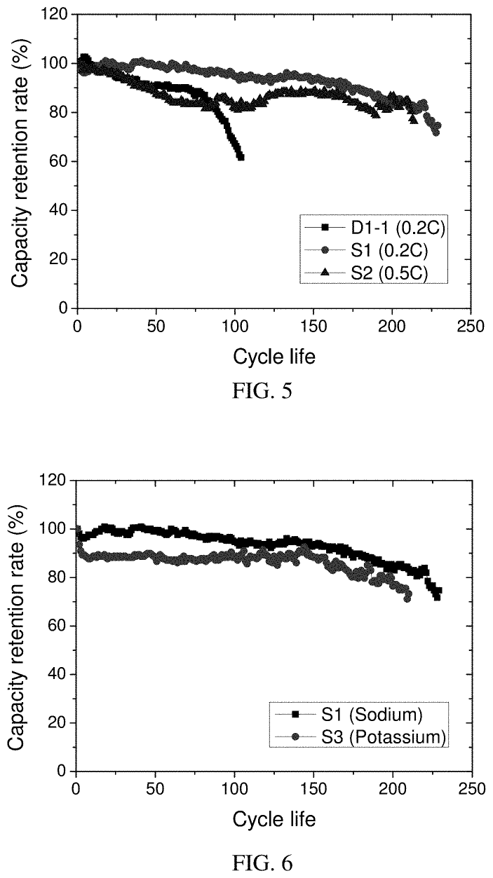

FIG. 5 illustrates the cycle performance of the batteries at different rate. As shown in FIG. 5, addition of both sodium sulfate and PEG can improve the rate performance at both 0.2 C and 0.5 C.

### Example 3

Preparation of electrolyte solution 3 (S3) comprises the following steps:

Weighing a certain amount of lithium sulfate, zinc sulfate, potassium sulfate and polyethylene glycol, adding them into deionized water to ensure that the concentration of zinc ion, lithium ion, potassium ion is 2M, 2.4M and 0.4M respectively and the concentration of polyethylene glycol is 400 ppm, thus to obtain the electrolyte solution S3.

Prepare a battery according to the method of Example 1 and test its cycle performance, and the results are shown in FIG. 6.

As shown in FIG. 6, the use of sodium salt and potassium salt as the neutral alkali metal salt in the electrolyte solution of the disclosure can increase the cycle life the battery.

### Examples 4 and 5

Prepare electrolyte solution of different ion concentration according to the method of Example 1. The detailed concentration of each ion is shown in Table 1.

TABLE 1

| | No. of | Concentration | Concentration | Concentration | Concentration | Concentration |
|---|---|---|---|---|---|---|
| No. of | Electrolyte | of Zinc Ion | of Lithium Ion | of Sodium Ion | of Potassium Ion | of PEG |
| Example | Solution | (M) | (M) | (M) | (M) | (ppm) |
| Example 4 | S4 | 2 | 2.4 | 0.2 | 0.2 | 400 |
| | D4 | 2.1 | 2.6 | — | — | — |
| Example 5 | S5 | 2.1 | 2.4 | 0.2 | — | 400 |
| | D5 | 2.1 | 2.6 | — | — | — |

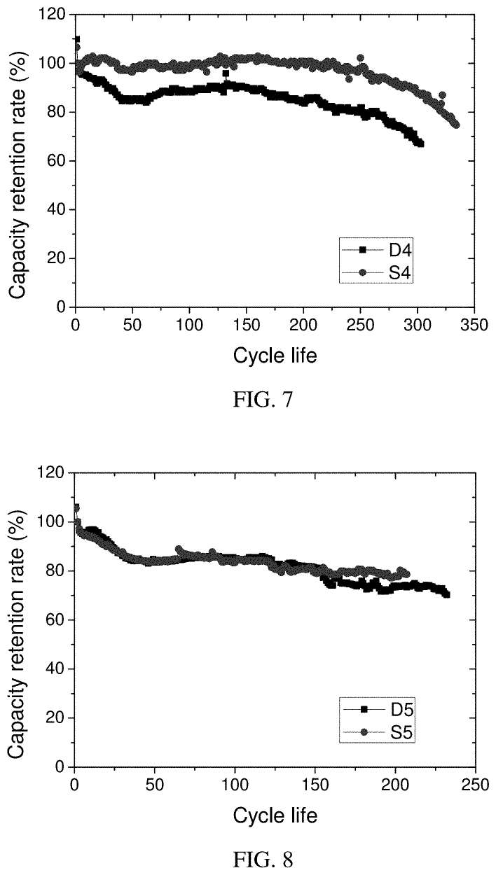

Assemble batteries with the above electrolyte solutions and test their cycle performance, and the results are shown in FIG. 7 and FIG. 8. It can be seen that, compared with the control group of electrolyte solution without additives, the cycle performance of the battery is improved after addition of the additives of different concentration described herein. It should be noted that improved formula for positive pole is used for S4 and S5 as well as the corresponding control groups D4 and D5. Specifically, titanium and platinum current collector and 1% styrene butadiene rubber (SBR) are used for the positive pole of D1-1, S1, S2 and S3 of Examples 1-3; titanium and platinum current collector, 2% styrene butadiene rubber (SBR) and 0.3% succinonitrile (SN) are used for the positive pole of S4 and the corresponding control group D4, and the outer surface of positive plate is coated with graphene; stainless steel current collector, 2% styrene butadiene rubber (SBR) and 0.3% succinonitrile (SN) are used for the positive pole of S5 and the corresponding control group D5.

### Examples 6-9

Prepare electrolyte solution of different ion concentration according to the method of Example 1. The detailed concentration of each ion is shown in Table 2.

TABLE 2

| | No. of | Concentration | Concentration | Concentration | Concentration | Molecular | Concentration |
|---|---|---|---|---|---|---|---|
| No. of | Electrolyte | of Zinc Ion | of Lithium Ion | of Sodium Ion | of Potassium Ion | Weight of | of PEG |
| Example | Solution | (M) | (M) | (M) | (M) | PEG | (ppm) |
| Control group | D6 | 2.1 | 2.6 | — | — | — | — |
| Example 6 | S6 | 2 | 2.4 | 0.4 | — | 400 | 2000 |
| Example 7 | S7 | 2 | 2.4 | 0.4 | — | 200 | 400 |
| Example 8 | S8 | 2 | 2.4 | 0.4 | — | 600 | 400 |
| Example 9 | S9 | 2 | 2.4 | 0.4 | — | 20000 | 400 |

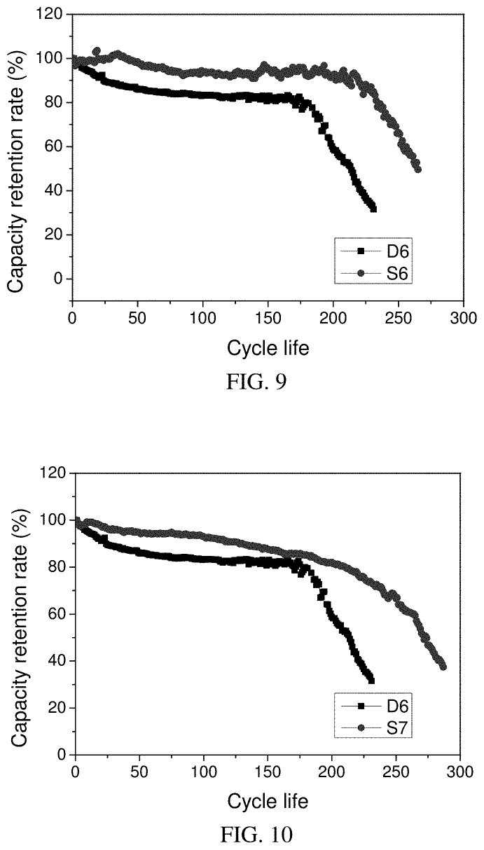

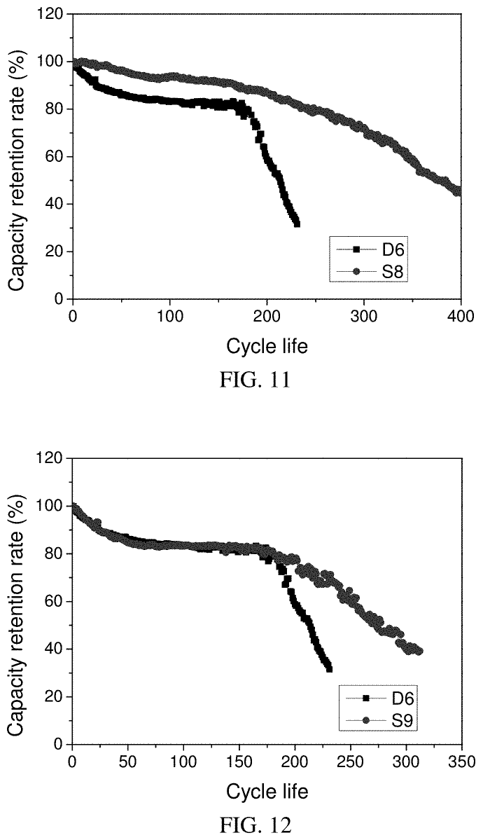

Assemble batteries with the above electrolyte solutions S6-S9 and test their cycle performance, and the results are shown in FIG. 9-12. It can be seen that, compared with the control group D6 of electrolyte solution without additives, the cycle performance of the battery is improved after addition of the additives of different concentration described herein. It should be noted that mass production formula for positive pole is used for S6-S9 and the corresponding control group D6. Specifically, stainless steel current collector, 2% styrene butadiene rubber (SBR) and 0.3% succinonitrile (SN) are used for the positive pole.

The previously described invention has many advantages. The advantages include an electrolyte solution, a battery and a battery pack that are safe, efficient, novel and low cost. The electrolyte solution includes an aqueous electrolyte and an additive system. The additive system includes a neutral alkali metal salt and an oxygen-enriched compound which delays battery capacity decay, and increases charge capacity. The battery includes the electrolyte solution, cathode and anode. The battery pack includes a plurality of the batteries. The battery that includes an additive system containing both NAMS and oxygen-enriched compound (for example, PEG) offers tremendous advantages in rechargeable batteries due to increasing the battery capacity and cycle life, which makes this especially valuable in meeting the growing demands to find compact power sources specifically with long battery life.

Throughout the description and drawings, example embodiments are given with reference to specific configurations. It can be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. An electrolyte solution comprising:
an aqueous electrolyte and,
an additive system,
the additive system comprising a neutral alkali metal salt and an oxygen-enriched compound;
wherein the aqueous electrolyte comprises anode metal ions that can be reduced and deposited to form a metal at an anode electrode during a charge-discharge process, whereby the metal is capable of being reversibly oxidized and dissolved.

2. The electrolyte solution according to claim 1, wherein the neutral alkali metal salt comprises an alkali metal sulfate.

3. The electrolyte solution according to claim 2, wherein the alkali metal salt comprises at least one salt selected from the group consisting of sodium sulfate, potassium sulfate, rubidium sulfate and cesium sulfate.

4. The electrolyte solution according to claim 1, wherein the neutral alkali metal salt is present in a molar concentration from about 0.1M to about 0.8M.

5. The electrolyte solution according to claim 1, wherein the oxygen-enriched compound comprises at least one compound selected from the group consisting of polyethylene glycol, polysorbate, nonylphenol polyethylene glycol ether, polyoxyethylene octyl phenyl ether, polypropylene glycol, polyglycerol and polyethyleneimine.

6. The electrolyte solution according to claim 5, wherein the oxygen-enriched compound is polyethylene glycol.

7. The electrolyte solution according to claim 1, wherein the oxygen-enriched compound is present in a concentration from 100 ppm to 200000 ppm by weight.

8. The electrolyte solution according to claim 6, wherein the polyethylene glycol is present with a weight-average molecular weight from about 200 Da to about 2000 Da.

9. The electrolyte solution according to claim 1, wherein the electrolyte solution comprises an electrolyte from about pH 4 to about pH 6.

10. The electrolyte solution according to claim 1, wherein the anode metal ion comprises zinc ions.

11. The electrolyte solution according to claim 1, wherein the aqueous electrolyte comprises zinc ions and a lithium ions.

12. The electrolyte solution according to claim 11, wherein the zinc ions are present in a concentration from about 0.1M to about 3 M; and the lithium ions are present in a concentration from 0.1M to about 3 M.

13. The electrolyte solution according to claim 1, wherein the electrolyte solution comprises a solvent that is at least one of water and alcohol.

14. The electrolyte solution according to claim 13, wherein the solvent is water.

15. An electrolyte solution comprising:
an aqueous electrolyte; and,
an additive system,
wherein the additive system comprises at least one neutral alkali metal salt selected from the group consisting of sodium sulfate, potassium sulfate, rubidium sulfate and cesium sulfate; and, polyethylene glycol;
wherein the aqueous electrolyte contains anode metal ions that can be reduced and deposited to form a metal at an anode electrode during a charge-discharge process, whereby the metal is capable of being reversibly oxidized and dissolved.

16. A battery, comprising:
a cathode;
an anode; and,
an electrolyte solution comprising an aqueous electrolyte and an additive system;
wherein the additive system comprises a neutral alkali metal salt and an oxygen-enriched compound;
whereby the aqueous electrolyte comprises anode metal ions that can be reduced and deposited to form a metal at an anode electrode during a charge-discharge process, the metal capable of being reversibly oxidized and dissolved.

17. The battery according to claim 16, wherein the cathode comprises a lithium-based electrode material.

18. The battery according to claim 16, wherein the anode comprises zinc-based electrode material.

19. A battery pack comprising a plurality of batteries; wherein the battery comprises the battery of claim 16.
